(19) United States
(12) Patent Application Publication
(10) Pub. No.: US 2011/0238708 A1
(43) Pub. Date: Sep. 29, 2011

(54) DATABASE MANAGEMENT METHOD, A DATABASE MANAGEMENT SYSTEM AND A PROGRAM THEREOF

(75) Inventors: Takehiko KASHIWAGI, Tokyo (JP); Junpei KAMIMURA, Tokyo (JP)

(73) Assignee: NEC CORPORATION, Tokyo (JP)

(21) Appl. No.: 13/050,567

(22) Filed: Mar. 17, 2011

(30) Foreign Application Priority Data
Mar. 29, 2010 (JP) 2010-074384

(51) Int. Cl. G06F 7/00

(52) U.S. Cl. 707/803; 707/E17.005

(57) ABSTRACT

A database management method and a database management system are provided. A management server generates data which is described in the same data format as the data stored in a database and adds the generated data in the database. The data format includes a column for inputting information indicating whether or not the data is sorted.

### CROSS REFERENCE TO RELATED APPLICATIONS

This application is based upon and claims the benefit of priority from Japanese patent application No. 2010-074384, filed on Mar. 29, 2010, the disclosure of which is incorporated herein in its entirety by reference.

### BACKGROUND

1. Field

Exemplary embodiments described herein relate to a database management method, a database management system and a program thereof. More particularly, they relate to a database management method, a database management system and a program thereof capable of preventing the performance reduction due to the data addition process while maintaining high speed in the data reading process of the column-store database.

2. Description of Related Art

A column-store database system for managing data in units of columns has been invented as a form of database system. In general, the database structure in such a system has been designed to store symbol values in sorted order to maintain high speed in the reading process.

For example, PCT International Publication No. WO 00/10103 (hereinafter, Patent Document 1) discloses a database system and item value number assignment information array (a pointer array to the value management table). The database system includes a value management table in which item values are stored in the order of item value number. In an item value number assignment information array, information for specifying the item value numbers is stored in the order of record.

In the database system described in Patent Document 1, data is added by determining whether new data is already present in the value management table. When the new data is present, the database system maintains the order of the data in the value management table. Otherwise, the database system recalculates the order of all of the data in the value management table. When the value is already present in the value management table, the item value number assignment information array is not changed. However, if there is a change in the order of the value management table, a data change also occurs widely in the item value number assignment information array, leading to a reduction of the performance.

### SUMMARY OF THE INVENTION

An object of the exemplary embodiment is to provide a database management method, a database management system and a program capable of preventing the reduction of the performance due to the data addition process while maintaining high speed in the data reading process of the column-store database.

According to an aspect of non-limiting illustrative embodiment, there is provided a database management method including: generating data which is described in a data format that is the same format as data stored in a database; and adding the generated data in the database, wherein the data format includes a column for inputting information indicating whether or not the data is sorted.

According to an aspect of another exemplary embodiment, there is provided a database management system including: a database configured to store data; a management server configured to generate data which is described in a data format that is the same format as the data stored in the database and add the generated data in the database, wherein the data format includes a column for inputting information indicating whether or not the data is sorted.

According to an aspect of another exemplary embodiment, there is provided a computer readable medium recording thereon a program for enabling a computer to perform a database management method, the method including: generating data which is described in a data format that is the same format as data stored in a database; and adding the generated data in the database, wherein the data format includes a column for inputting information indicating whether or not the data is sorted.

### BRIEF DESCRIPTION OF THE DRAWINGS

Other exemplary aspects and advantages of various exemplary embodiments will become apparent by the following detailed description and the accompanying drawing, wherein:

FIG. 1 is a schematic diagram indicating a system configuration of a database system in a first exemplary embodiment;

FIG. 2 is a view of the data structure in the database;

FIG. 3 is a flowchart explaining operation of the database system;

FIG. 4 is a view for explaining operation of the database system;

FIG. 5 is a view for explaining operation of the database system;

FIG. 6 is a view for explaining operation of the database system;

FIG. 7 is a view for explaining operation of the database system;

FIG. 8 is a view for explaining operation of the database system;

FIG. 9 is a view for explaining operation of the database system;

FIG. 10 is a view for explaining operation of the database system; and

FIG. 11 is a view for explaining the integration of regions.

### DETAILED DESCRIPTION

A first exemplary embodiment is described in detail below by referring to the drawings.

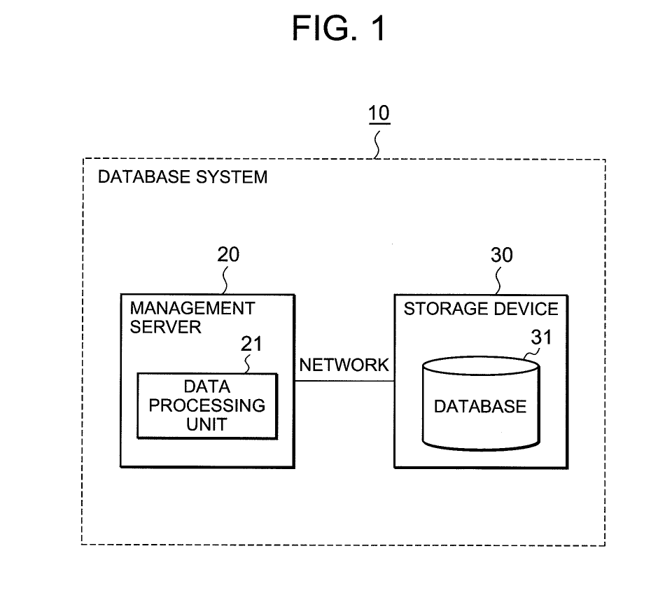

FIG. 1 is a schematic diagram of the system structure of a database system 10. As shown in the figure, the system includes a management server 20 and a storage device 30. The management server 20 and the storage device 30 are connected via a network such as a local area network (LAN). In this exemplary embodiment, data is stored and managed by a column-store database that manages data in units of columns.

The management server 20 includes a data processing unit 21 for performing various processes such as reading and changing data of a database 31 stored in the storage device 30. The database 31 is stored in the storage device 30. The database 31 is a column-store database for managing data in units of columns.

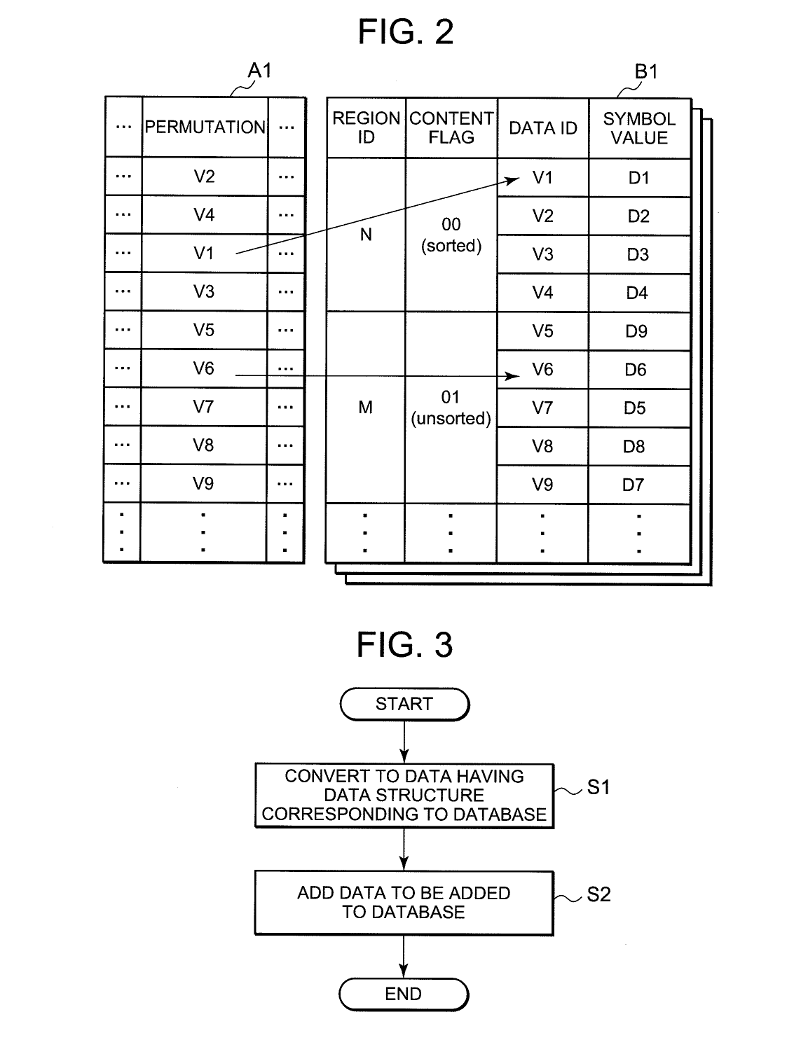

FIG. 2 shows an example of the data structure of the database 31. The database has a data structure in which a permutation matrix part A1 and a column data part B1 are provided.

The permutation matrix part A1 shows the order in the row direction of data of symbol values for each column, by data identifiers corresponding to the individual symbol values.

The column data part B1 is a part in which a plurality of regions (data subsets) are stored. Each region includes symbol values (data values) included in the specific region, identification values of the individual symbol values, a region ID, and a content flag indicating whether the individual symbol values of the specific region are sorted.

The identification values of the individual symbol values may be numbered sequentially throughout the column data part B1. Further, the region ID is set to the maximum value of the identification values of the individual symbol values in the specific region.

Next, an operation for adding data to the database 31 in the database system 10 is explained with reference to FIG. 3. FIG. 3 is a flowchart of the operation of the process performed by the management server 20.

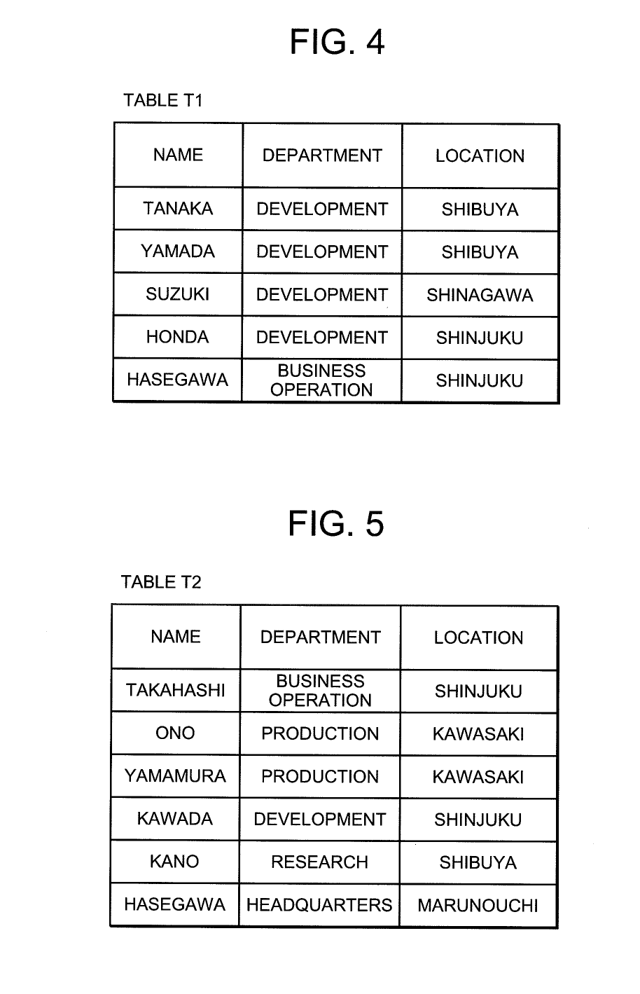

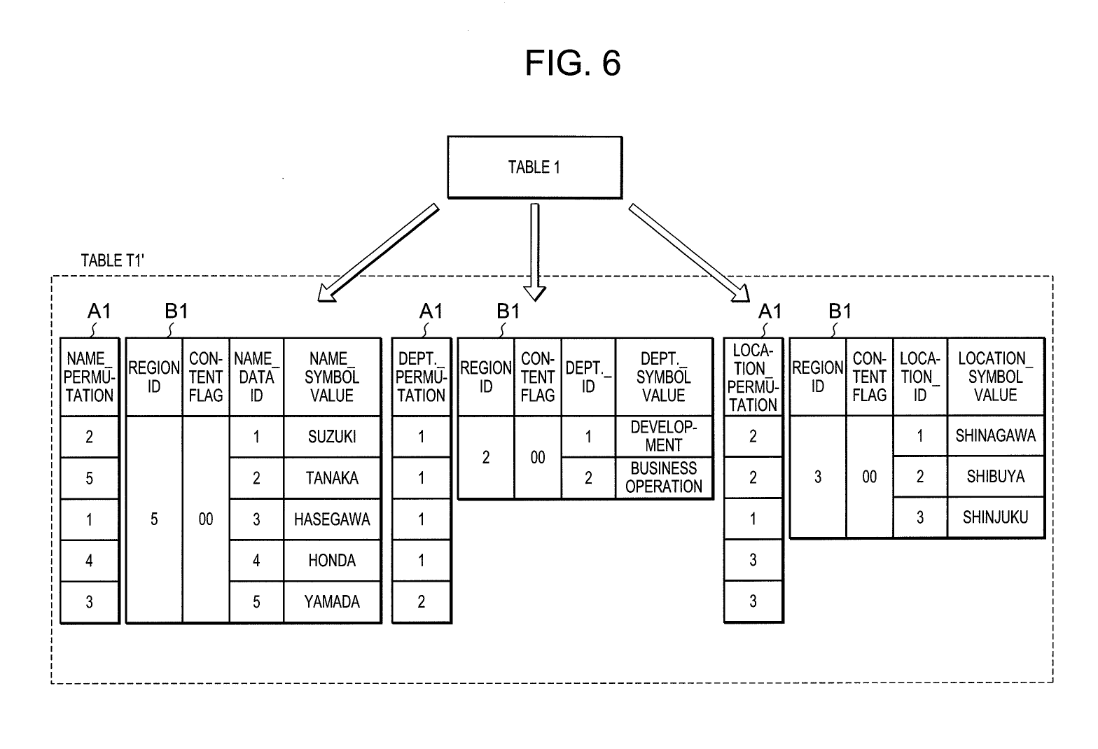

In this exemplary embodiment, a process for adding a table T2 of FIG. 5 to a table T1 of FIG. 4 is performed. In the database 31, the entity data of the table T1 is stored according to the above data structure (see FIG. 2) in units of columns as shown in a table T1′ in FIG. 6.

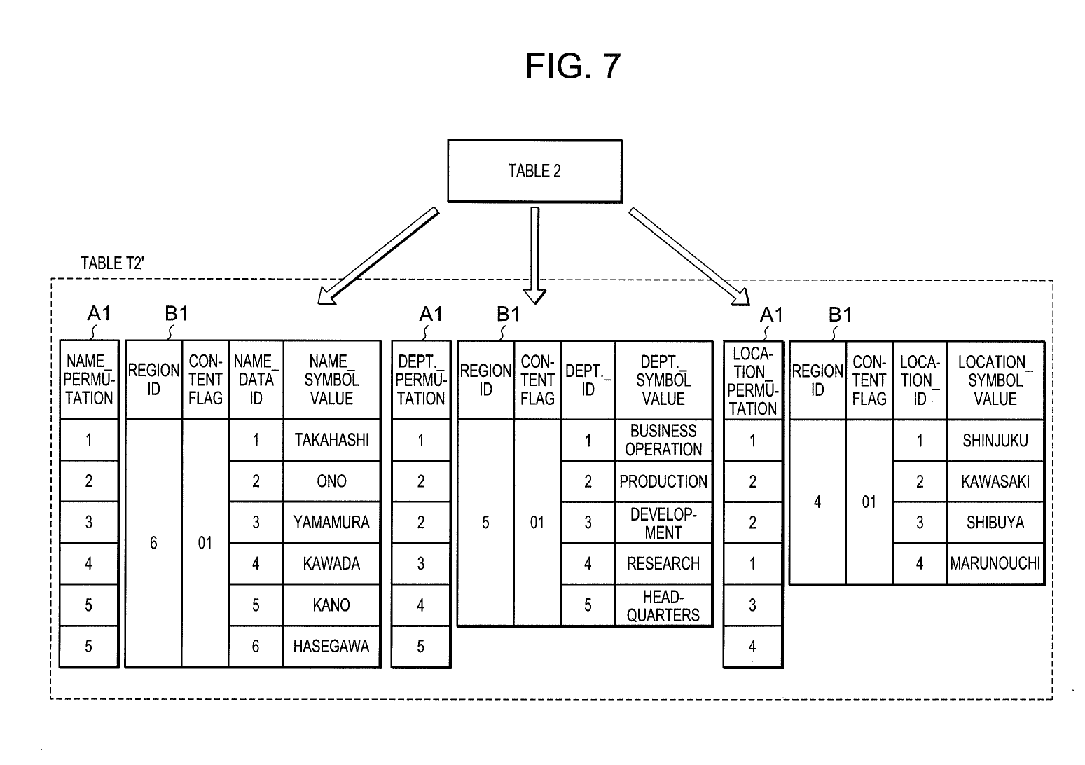

The data processing unit 21 of the management server 20 converts the data of the table T2 to be added, into data having the data structure corresponding to the database 31 as shown in a table T2′ in FIG. 7 (operation S1). At this time, the identification values of the individual symbol values are numbered sequentially throughout the specific subset. Then, the maximum number of the identification values of the individual symbol values is set to the region ID. Further, the content flag is set to indicate whether the symbol values in the specific data set are sorted. More specifically, a flag “00” is set when the symbol values are sorted, and a flag “01” is set when the symbol values are not sorted.

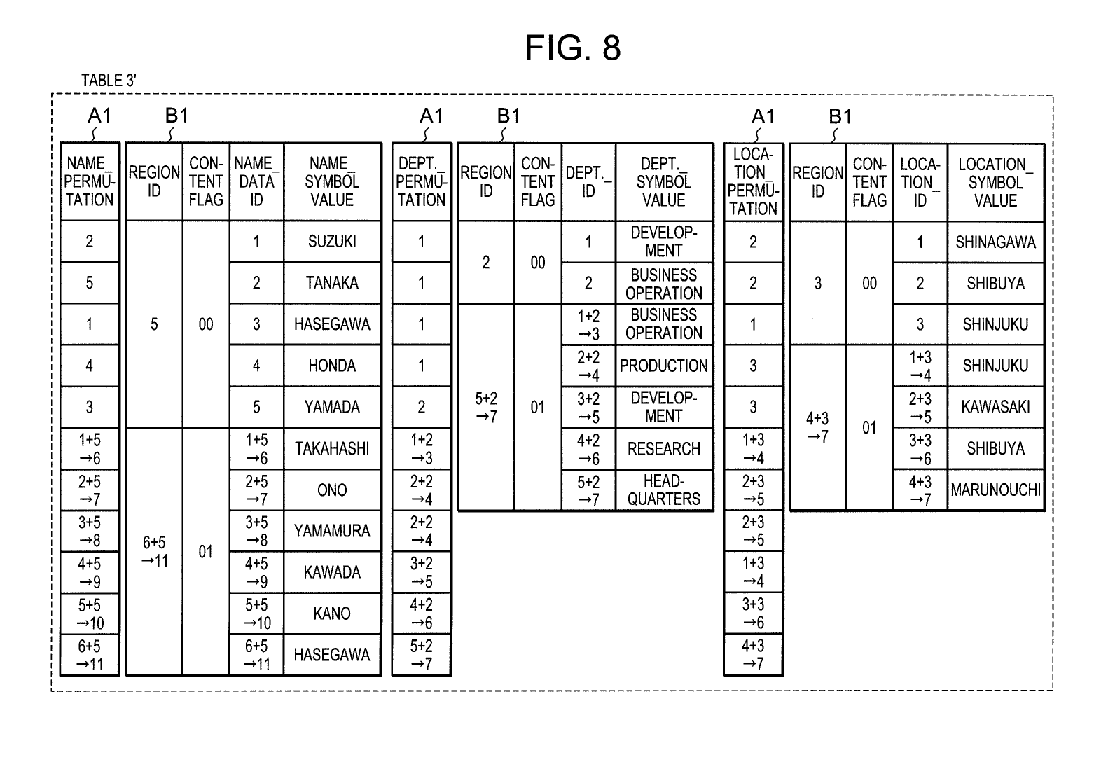

Next, the data processing unit 21 adds the data to be added to the database 31 (operation S2). Here, as shown in a table T3′ in FIG. 8, the data processing unit 21 adds the region ID of the data subset having been stored in the column data part B1, to each of the permutation values to be added of the permutation matrix part A1, and to each of the identification values of the individual symbol values in the data subset to be added. At the same time, the data processing unit 21 sets the region ID of the data subset to be added, to the maximum value of the identification values of the individual symbol values in the data subset to be added.

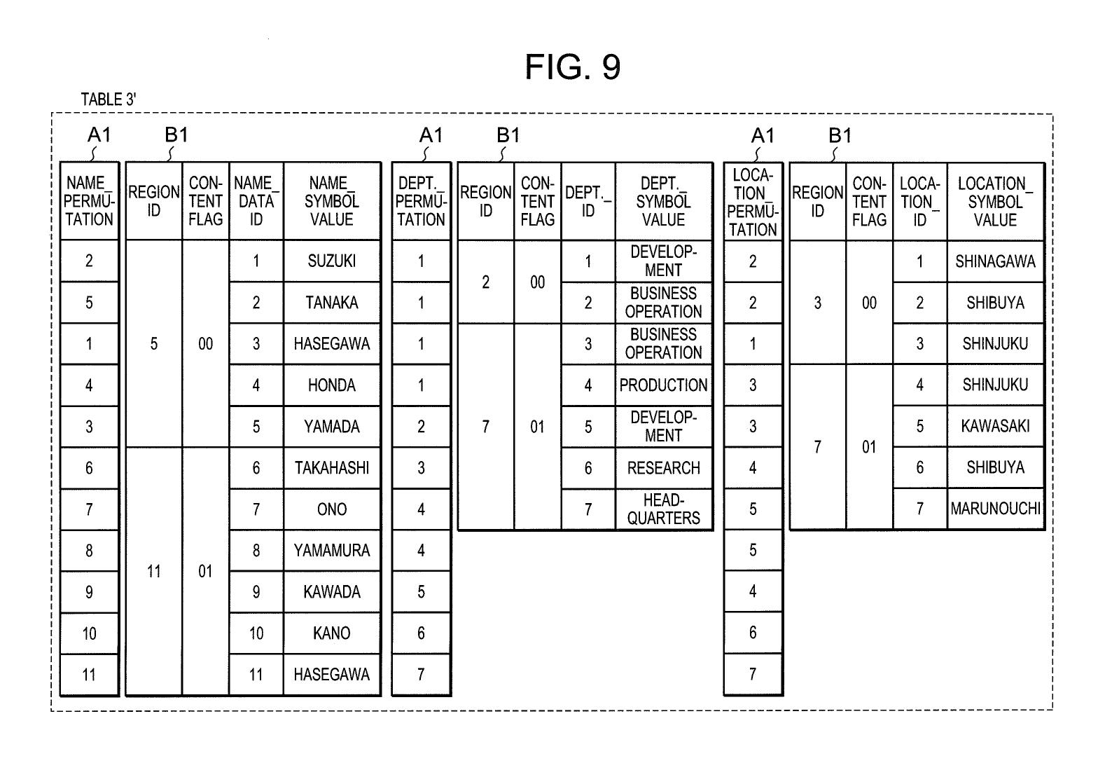

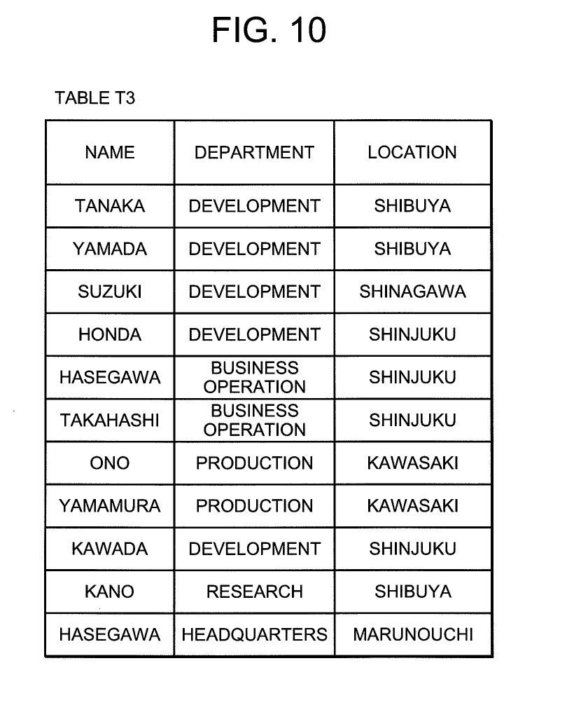

By means of the data addition process described above, the entity data shown in FIG. 9 is stored in the database 31. Then, a table 3 of FIG. 10 is obtained. In this way, it is possible to maintain alignment in the database only by simply connecting each data subset generated based on the data structure shown in FIG. 2, and by storing the data in the database.

As described above, in database system 10, the data change is performed only with respect to the portion of the data to be added. Thus, it is possible to prevent the reduction of the performance of the database system 10. Further, the region (data subset) of the column data part includes a flag indicating whether the symbol values in the region are sorted. The data reading process refers to the flag in order to determine whether the symbol values in the region are in sorted order. As a result, it is possible to maintain high speed in the reading process. In addition, the data change range is smaller than that in the conventional data change process. As a result, the process of the data base system in this exemplary embodiment can be performed faster than the conventional process.

With respect to the data to be added, a change is only made by simply adding the region ID of the existing data structure to the contents of the data to be added, regardless of whether the contents of the symbol value storage structure part are sorted. At this time there is no need to perform complicated calculations. Thus, it is possible to effectively perform the process by using a parallel calculator. In addition, high speed calculation can be achieved in terms of the cache hit ratio.

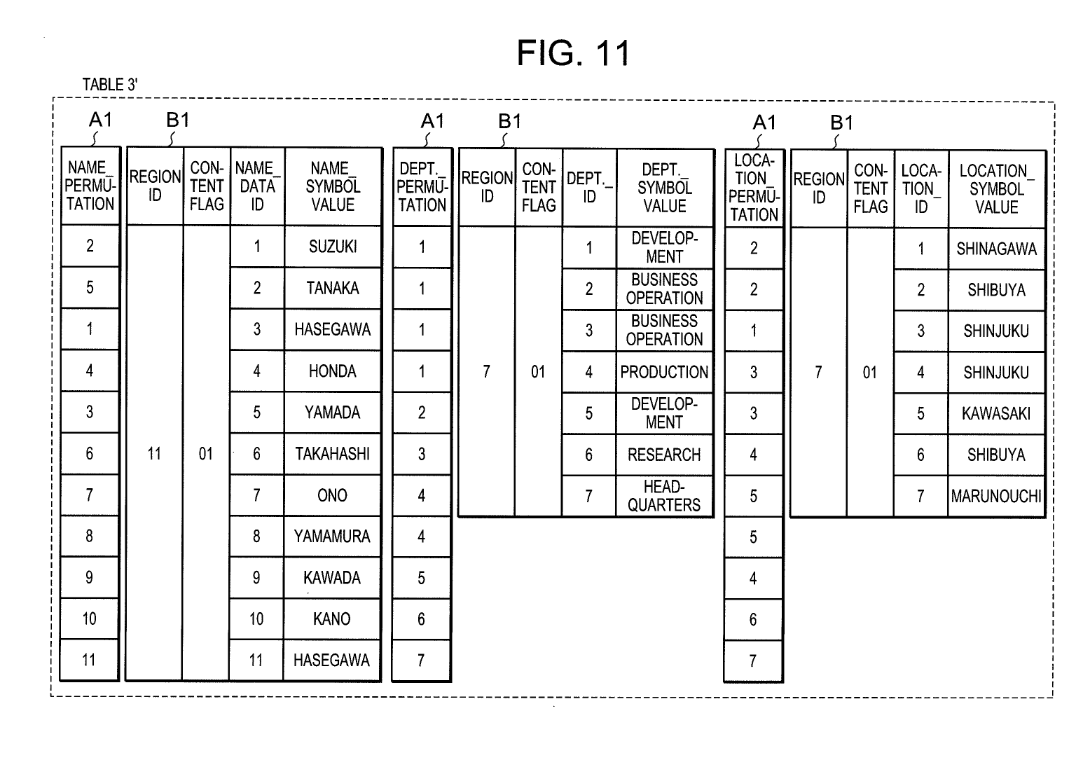

The management server 20 may integrate the regions at a predetermined timing, for example, a passing time. When the data (symbol values) stored in the database 31 are in sorted order and not redundant with the data to be added, and when the data to be added are already sorted and not overlapped with the data range, it is possible to maintain a sorted state by simply adding the data. For this reason, the set value of the content flag continues to indicate that the data are sorted. Further, when one of the regions to be integrated is not sorted, the content flag of the region is set to indicate that the data are not sorted. In such a case, a data integration algorithm or other method can be used to integrate the structure in a fully sorted state. FIG. 11 shows an example of the data structure when the regions are integrated with respect to the data of FIG. 9.

The data processing unit 21 of the management server 20 in this exemplary embodiment may be realized by a central processing unit (CPU) of the management server 20. At this time, the CPU reads and executes an operation program, and the like, stored in the storage device. Alternatively, the data processing unit 21 may be implemented by hardware. It is also possible to realize only a part of the functions of the embodiment described above by a computer program.

The above embodiment adds the data to the database by setting the region ID of the data to be added to the maximum value of the identification values of the individual symbol values in the specific region. However, the embodiment is not limited to this configuration. It is also possible to add the region ID of the data subset having been stored in the column data part B1.

In the implementation of the database system in which data change may occur, this exemplary embodiment is appropriate for the application in which a faster addition process response is required, without substantially degrading fast reading response. For example, in a database for log management in which a large number of data are expected to be added, the contents of the last data can be reflected to the result, while allowing a large number of logs to be analyzed at high speed.

The above-described exemplary embodiments are non-limiting, and can be implemented in various forms.

Although exemplary embodiments have been shown and described, it would be appreciated by those skilled in the art that changes may be made in these embodiments without departing from the principles and spirit of the inventive concept, the scope of which is defined in the claims and their equivalents.

What is claimed is:

1. A database management method comprising:
generating data which is described in a data format that is the same format as data stored in a database; and
adding the generated data in the database,
wherein the data format includes a column for inputting information indicating whether or not the data is sorted.

2. The database management method according to claim 1,
wherein the data format comprises:
a column data part which includes data for each column and identification information for each data; and
a permutation matrix part which includes order information indicating the order of the identification information.

3. The database management method according to claim 2, further comprising:
updating the identification information of the generated data in order not to overlap with the identification information of the data stored in the database, when the identification information of the generated data overlaps with the identification information of the data stored in the database.

4. The database management method according to claim 2,
wherein the column data part includes region identification information indicating a group of the data.

5. A database management system comprising:
a database configured to store data;
a management server configured to generate data which is described in a data format that is the same format as the data stored in the database and add the generated data in the database,
wherein the data format includes a column for inputting information indicating whether or not the data is sorted.

6. The database management system according to claim 5,
wherein the data format comprises:
a column data part which includes data for each column and identification information for each data; and
a permutation matrix part which includes order information indicating the order of the identification information.

7. The database management system according to claim 6,
wherein the management server updates the identification information of the generated data in order not to overlap with the identification information of the data stored in the database when the identification information of the generated data overlaps with the identification information of the data stored in the database.

8. The database management system according to claim 6,
wherein the column data part includes region identification information indicating a group of the data.

9. A computer readable medium recording thereon a program for enabling a computer to perform a database management method, the method comprising:
generating data which is described in a data format that is the same format as data stored in a database; and
adding the generated data in the database,
wherein the data format includes a column for inputting information indicating whether or not the data is sorted.

10. The computer readable medium according to claim 9,
wherein the data format comprises:
a column data part which includes data for each column and identification information for each data; and
a permutation matrix part which includes order information indicating the order of the identification information.

11. The computer readable medium according to claim 10, the method further comprising:
updating the identification information of the generated data in order not to overlap with the identification information of the data stored in the database when the identification information of the generated data overlaps with the identification information of the data stored in the database.

12. The computer readable medium according to claim 10,
wherein the column data part includes region identification information indicating a group of the data.
